(19) United States
(12) Patent Application Publication
(10) Pub. No.: US 2017/0297702 A1
(43) Pub. Date: Oct. 19, 2017

(54) VIBRATION CONTROL METHOD FOR FLAPPING-WING MICRO AIR VEHICLES

(71) Applicant: UNIVERSITY OF SCIENCE AND TECHNOLOGY BEIJING, Beijing (CN)

(72) Inventors: Wei He, Beijing (CN); YuNan Chen, Beijing (CN); Tong Lv, Beijing (CN); Yao Yu, Beijing (CN); ChangYin Sun, Beijing (CN)

(73) Assignee: UNIVERSITY OF SCIENCE AND TECHNOLOGY BEIJING

(21) Appl. No.: 15/467,449

(22) Filed: Mar. 23, 2017

(30) Foreign Application Priority Data
Mar. 23, 2016 (CN) 201610169573.6

(51) Int. Cl. B64C 33/02; B64C 13/16

(52) U.S. Cl. CPC B64C 33/02; B64C 13/16

(57) ABSTRACT

The present invention provides a method for controlling the oscillation of flapping-wing air vehicle, which comprises the following steps: calculating the kinetic energy, potential energy and virtual work of the system using the flexible wing with the two-degree of freedom as the research object; establishing system dynamics model based on the Hamilton's principle; setting the boundary control rate according to said system dynamics model wherein said boundary control rate includes F(t) and M(t), said F(t) is the inputted boundary control force, and said M(t) is the inputted boundary torque; and controlling the flexible wings according to the system dynamics model in combination with the boundary control rate. The present invention establishes the system dynamics model based on the Hamilton's principle, set the boundary control rate according to said system dynamics model, sufficiently considers the situation of distributed disturbance occurring at the boundary and effectively prevents the flexible wings deformation caused by the external disturbances.

### CROSS-REFERENCE TO RELATED APPLICATIONS

This application claims priority benefit to Chinese Patent Application No. 201610169573.6 filed Mar. 23, 2016. The content of the aforementioned application, including any intervening amendments thereto, is incorporated herein by reference.

### FIELD OF THE INVENTION

This invention relates to the field of automatic control technology, and especially to a method for controlling the oscillation of flapping-wing air vehicle.

### BACKGROUND TO THE INVENTION

In recent years, along with the continuous increase of people to the unmanned aerial vehicle (UAV) technology, and the rapid development of the advanced manufacturing technology (AMT), the new material technology and the new energy technology, the research on the micro flying machines have been the technical hot points.

Due to the increased demands to the UAV in civil and military usages, the designers are striving to reduce the weight of the UAV while improve the maneuverability of the system. Therefore, at present, the flexible wing with lighter weight is usually adopted in the UAV design. Compared with the rigid wing, the flexible wing mainly has the advantages of good flexibility, good cost/benefit, better agility, and excellent performance, etc. However, the flexible wing is easy to oscillate, and thus causing the unexpected error.

### SUMMARY OF THE INVENTION

The technical problem to be solved by this invention is to provide a method for controlling the oscillation of flapping-wing air vehicle which is able to effectively prevent the problem of flexible wing deformation caused by the external disturbances.

The method for controlling the oscillation of flapping-wing air vehicle comprises the steps of:

Calculating the kinetic energy, potential energy, and virtual work of the system using the flexible wing with the two-degree of freedom as the research object;

Establishing the system dynamics model based on Hamilton's principle;

Setting up the boundary control rate according to said system dynamics model wherein said boundary control rate includes F(t)and M(t), said F(t) is the inputted boundary control force, and said M(t) is the inputted boundary torque; and

Controlling the oscillation of the flexible wing according to the system dynamics model and by combining the boundary control rate.

The advantageous effects of the present invention are as following:
the above technical solution establishes the system dynamics model based on the Hamilton's principle, set the boundary control rate according to said system dynamics model, considers the situation of distributed disturbance occurring at the boundary sufficiently, and effectively prevents the flexible wings deformation caused by the external disturbances, thus is able to control the flexible wing accurately and stably.

### BRIEF DESCRIPTION OF THE SEVERAL VIEWS OF THE DRAWING

The invention will be described, by way of example, with reference to the accompanying drawings, in which:

FIG. 1. is the flow diagram of the method of this invention for controlling the oscillation of the flapping-wing air vehicle;

FIG. 2 is the figure of simulation of the bending displacement under the interference of the method of this invention for controlling the oscillation of the flapping-wing air vehicle;

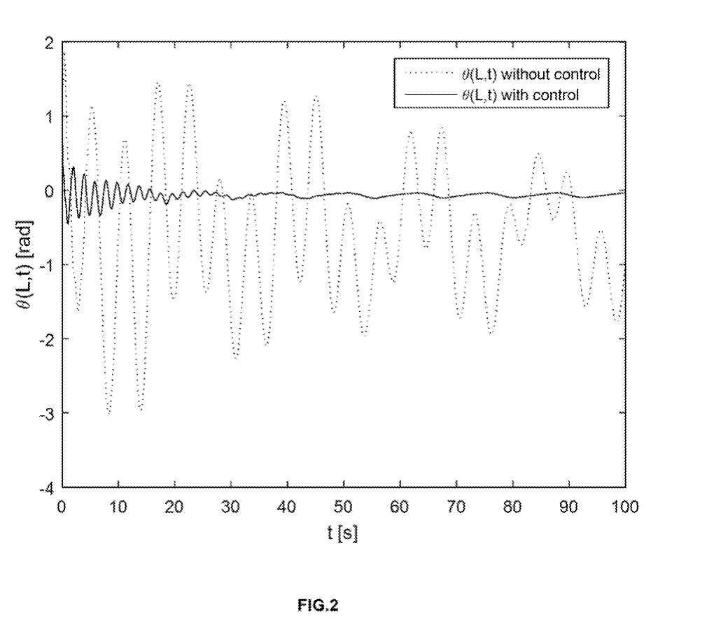

FIG. 3. is the simulation of the torsional displacement under the interference of the method of this invention for controlling the oscillation of the flapping-wing air vehicle.

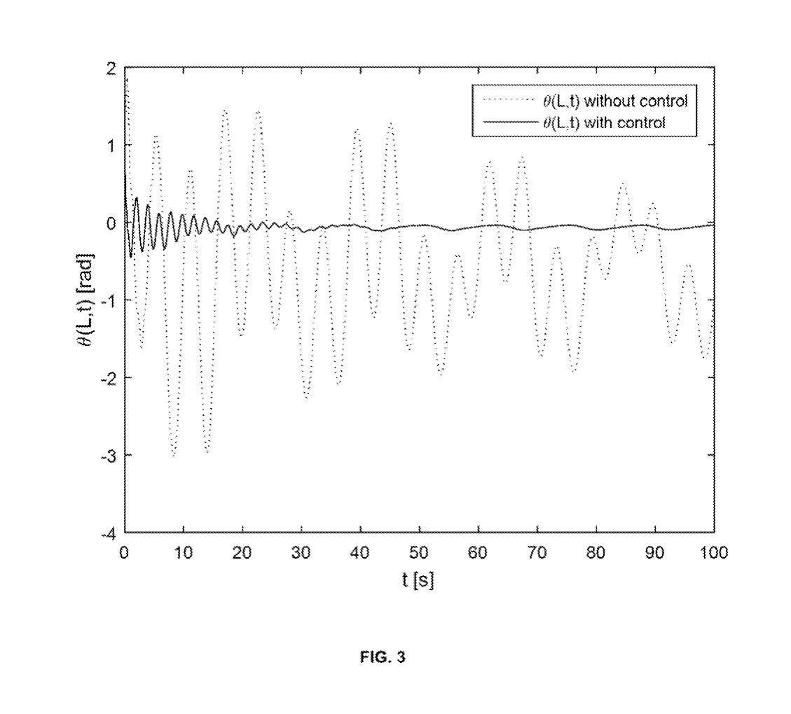

### DETAILED DESCRIPTION OF PREFERRED EMBODIMENT

In order to make the technical problem to be solved by this invention, the technical solution and the advantages clear, the invention will be described by way of example, with reference to the accompanying drawings, in which:

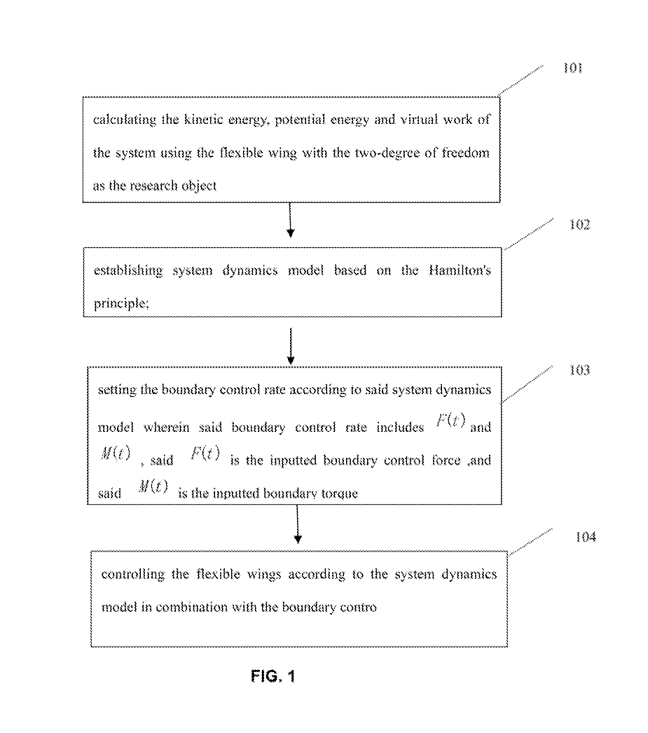

As shown in FIG. 1, the method for controlling the oscillation of flapping-wing air vehicle, in the example of this invention, which comprises the steps of:

Step 101: calculating the kinetic energy, potential energy, and virtual work of the system using the flexible wing with the two-degree of freedom as the research object;

Step 102: establishing the system dynamics model based on Hamilton's principle,

Step 103: setting up the boundary control rate according to said system dynamics model wherein said boundary control rate includes F(t) and M(t), said F(t) is the inputted boundary control force, and said M(t) is the inputted boundary torque; and

Step 104: controlling the oscillation of the flexible wing according to the system dynamics model and by combining the boundary control rate.

The method for controlling the oscillation of flapping-wing air vehicle in the example of this invention establishes the system dynamics model based on the Hamilton's principle, set the boundary control rate according to said system dynamics model, considers the situation of distributed disturbance occurring at the boundary sufficiently, and prevents the flexible wings deformation caused by the external disturbances effectively, thus is able to control the flexible wing accurately and stably.

Preferably, said calculating the kinetic energy, potential energy, and virtual work of the system using the flexible wing as the research object comprises:

Expressing the kinetic energy of the system, Eₖ(t) as follows:

$${E}_{k} ( t ) = \frac{1}{2} m {\int }_{0}^{L} {[ \dot{y} ( x , t ) ]}^{2} dx + \frac{1}{2} {I}_{p} {\int }_{o}^{L} {[ \dot{θ} ( x , t ) ]}^{2} dx , \qquad ( 1 )$$

wherein the spatial variable of x is independent to the time variable of t, and m is the unitspan mass of the flexible wing; Iₚ is inertial polar distance of the flexible wing; y(x, t) is the bending displacement at the position of x and at time of t in the x0y coordinate system; and θ(x, t) is the corresponding displacement of deflection angle;

The potential energy of Eₚ(t) is expressed as follows:

$${E}_{p} ( t ) = \frac{1}{2} {EI}_{b} {\int }_{0}^{L} {[ {y}^{″} ( x , t ) ]}^{2} dx + \frac{1}{2} GJ {\int }_{0}^{L} {[ {θ}^{′} ( x , t ) ]}^{2} dx , \qquad ( 2 )$$

wherein, EI_{b} denotes the flexural rigidity, GJ denotes the torsional rigidity; and the virtual work of caused by the above two rigidities δW_{c}(t) is expressed as follows:

δW_{c}(t)=mxₒc∫₀^{L}ÿ(x, t)δθ(x, t)dx+mxₒc∫₀^{L}\ddot{θ}(x, t)δy(x, t)dx (3),

Wherein, xₒc denotes the distance from the mass center of wing to the bending center; and the virtual work, δW_{d}(t) done by the Kelvin-Voigt damping force is expressed as follows:

δW_{d}(t)=−ηEI_{b}∫₀^{L}\dot{y}″(x, t)δy″(x, t)dx−ηGJ_{b}∫₀^{L}\dot{θ}′(x, t)δθ′(x, t)dx (4),

Wherein, η denotes the Kelvin-Voigtd damping coefficient.

The virtual work of done by the distributed distraction, δWᵣ(t) is as follows:

δWᵣ(t)=∫₀^{L}[F_{b}(x, t)δy(x, t)−xₐcF_{b}(x, t)δθ(x, t)]dx (5),

wherein xₐc denotes the distance from the aerodynamic center to the bending centre and; F_{b} is the unknown time varying distributed distraction along the wings;

The virtual work done by the boundary control force to the system, δWₐ(t) is expressed as follows:

δWₐ(t)=F(t)δy(L, t)+M(t)δθ(L, t) (6),

In the above formula, F(t) is the inputted boundary control force and; M(t) is the inputted boundary torque;

Consequently, the total virtual work is:

δW(t)=δ[W_{c}(t)+W_{d}(t)+Wᵣ(t)+Wₐ(t)] (7).

Preferably, said establishing the system dynamics model based on the Hamilton's principle includes:

utilizing the Hamilton's smooth action principle of
∫ₜ_{₁}^{t}^{₂}δ[Eₖ(t)−Eₚ(t)+W(t)]dt=0

Here δ denotes the variation symbol, and the governing equation for the system dynamics model is deduced as:

mÿ(x, t)+EI_{b}y″″(x, t)−mxₒc\ddot{θ}(x, t)+ηEI_{b}\dot{y}″″(x, t)=F_{b}(x, t) (8),

Iₚ\ddot{θ}(x, t)−GJθ″(x, t)−mxₒcÿ(x, t)−ηGJ\dot{θ}″(x, t)=−xₐcF_{b}(x, t) (9),

And the boundary conditions for the system dynamics model are deduced as:

y(0, t)=y′(0, t)=y″(L, t)=θ(0, t)=0 (10),

EI_{b}y′″(L, t)+ηEI_{b}\dot{y}′″(L, t)=−F(t) (11) and

GJθ′(L, t)+ηGJ\dot{θ}′(L, t)=M(t) (12).

Preferably, said setting the boundary controller based on the system dynamics model includes two controlling laws of
F(t) and M(t), wherein said F(t) is the inputted boundary control force and M(t) is the inputted boundary torque, and which includes:

Constructing the Lyapunov candidate function as follows:

Preferably, said setting the boundary controller based on the system dynamics model includes two controlling laws of

V(t)=V₁+Δ(t) (13),

Wherein, V₁(t) and Δ(t) are respectively defined as:

$$\begin{matrix}{V}_{1} ( t ) = \frac{β}{2} m {\int }_{0}^{L} {[ \dot{y} ( x , t ) ] }^{2} dx + \frac{β}{2} {EI}_{b} {\int }_{0}^{L} {[ {y}^{″} ( x , t ) ] }^{2} dx + \frac{β}{2} {I}_{p} {\int }_{0}^{L} {[ \dot{θ} ( x , t ) ] }^{2} dx + \frac{β}{2} GJ {\int }_{0}^{L} {θ}^{′} ( x , t ) ] 2 dx and & ( 14 ) \\ Δ ( t ) = α m {\int }_{0}^{L} \dot{y} ( x , t ) y ( x , t ) dx + α {I}_{p} {\int }_{0}^{L} \dot{θ} ( x , t ) θ ( x , t ) dx - α {mx}_{e} c {\int }_{0}^{L} [ \dot{y} ( x , t ) θ ( x , t ) + y ( x , t ) \dot{θ} ( x , t ) ] dx - β {mx}_{e} c {\int }_{0}^{L} \dot{y} ( x , t ) \dot{θ} ( x , t ) dx . & ( 15 )\end{matrix}$$

In the above two equations, both α and β are the smaller positive weight coefficient;
the boundary control rate is set by means of making the Lyapunov candidate function be positive definite, and derivative of Lyapunov candidate function of to the time of t, \dot{V}(t) is negative definite.

Preferably, said calculating the boundary control rate when the Lyapunov candidate function is positive definite, and the derivative of Lyapunov candidate function the time of t, \dot{V}(t) is negative definite comprises:

defining a new function as follows:

κ(t)=∫₀^{L}{[\dot{y}(x, t)]²+[\dot{θ}(x, t)]²+[y″(x, t)]²+[θ′(x, t)]²}dx (16),

Then V₁(t) has the upper bound and lower bound which are defined as

γ₂κ(t)≦V₁(t)≦γ₁κ(t) (17),

In the above formula,

$${γ}_{1} = \frac{β}{2} max ( m , {I}_{p} , {EI}_{b} , GJ ) , \\ {γ}_{2} = \frac{β}{2} min ( m , {I}_{p} , {EI}_{b} , GJ ) .$$

Further, Δ(t) is magnified as

$$\vert Δ ( t ) \vert \leq ( α m + α {mx}_{e} c + β {mx}_{e} c ) {\int }_{0}^{L} {[ \dot{y} ( x , t ) ] }^{2} dx + ( α {I}_{p} + α {mx}_{e} c + β {mx}_{e} c ) {\int }_{0}^{L} {[ \dot{θ} ( x , t ) ] }^{2} dx + ( α m + α {mx}_{e} c ) {L}^{4} {\int }_{0}^{L} {[ {y}^{″} ( x , t ) ] }^{2} dx + ( α {I}_{p} + α {mx}_{e} c ) {L}^{2} {\int }_{0}^{L} {[ {θ}^{′} ( x , t ) ] }^{2} dx \leq {γ}_{3} κ ( t ) , \qquad ( 18 )$$

### Wherein,

γ₃=max{αm+αmxₒc+βmxₒc, αIₚ+αmxₒc+βmxₒc, (αm+αmxₒc)L⁴, (αIₚ+αmxₒc)L²}, if the positive number, β satisfies

$$β > \frac{2 {γ}_{3}}{min ( m , {I}_{p} , {EI}_{b} , GJ )} ,$$

then

0≦λ₂κ(t)≦V(t)≦λ₃κ(t) (19).

This means that the constructed Lyapunov function is positive definite, wherein
λ₁=γ₁+γ₃ and λ₂=γ₂−γ₃;

The derivative of V(t) to t is deduced as:

\dot{V}(t)=\dot{V}₁(t)+\dot{Δ}(t) (20), and

\dot{V}₁(t)=βm∫₀^{L}\dot{y}(x, t)ÿ(x, t)dx+βIₚ∫₀^{L}\dot{θ}(x, t)\ddot{θ}(x, t)dx +βGJ∫₀^{L}θ′(x, t)\dot{θ}′(x, t)dx+βEI_{b}∫₀^{L}y″(x, t)\dot{y}″(x, t)dx (21)

By introducing the controlling equations (8) and (9) into the above formula, we obtain:

\dot{V}₁(t)=A₁+A₂+A₃+A₄+A₅+A₆ (22).

Wherein, A₁-A₆ are respectively expressed as follows:

A₁=−βEI_{b}∫₀^{L}\dot{y}(x, t)y″″(x, t)dx+βEI_{b}∫₀^{L}y″(x, t)\dot{y}″(x, t)dx (23),

A₂=−βηEI_{b}∫₀^{L}\dot{y}(x, t)\dot{y}″″(x, t)dx (24),

A₃=βmxₒc ∫₀^{L}[\dot{y}(x, t)\ddot{θ}(x, t)+ÿ(x, t)\dot{θ}(x, t)]dx (25),

A₄=β∫₀^{L}\dot{y}(x, t)F_{b}(x, t)dx−βxₒc∫₀^{L}\dot{θ}(x, t)F_{b}(x, t)dx (26),

A₅=βGJ∫₀^{L}\dot{θ}(x, t)θ″(x, t)dx+βGJ∫₀^{L}θ′(x, t)\dot{θ}′(x, t)dx (27), and

A₆=βηGJ∫₀^{L}\dot{θ}(x, t)\dot{θ}″(x, t)dx (28),

By utilizing the integration by parts and the boundary condition of (10) (11) and (12), we obtain

$$\begin{matrix} {A}_{1} = - β {EI}_{b} \dot{y} ( L , t ) {y}^{′′′} ( L , t ) = β \dot{y} ( L , t ) F ( t ) , & ( 29 ) \\ {A}_{2} \leq - βη \dot{y} ( L , t ) \dot{F} ( t ) - \frac{β η {EI}_{b}}{2 {L}^{4}} {\int }_{0}^{L} {[ \dot{y} ( x , t ) ] }^{2} dx - \frac{β η {EI}_{b}}{2} {\int }_{0}^{L} {[ {\dot{y}}^{″} ( x , t ) ] }^{2} dx \\ and & ( 20 ) \\ {A}_{4} \leq {σ}_{1} β {\int }_{0}^{L} {[ \dot{y} ( x , t ) ] }^{2} dx + {σ}_{2} β {x}_{a} c {\int }_{0}^{L} {[ \dot{θ} ( x , t ) ] }^{2} dx + ( \frac{β}{{σ}_{1}} + \frac{β {x}_{a} c}{{σ}_{2}} ) {LF}_{b max}^{2} , & ( 31 )\end{matrix}$$

wherein, σ₁ and σ₂ are the positive constants, F_{b max} is the maximum value of the distributed disturbance, F_{b}(x, t).

$$\begin{matrix} {A}_{5} = β GJ \dot{θ} ( L , t ) {θ}^{′} ( L , t ) = β \dot{θ} ( L , t ) M ( t ) , & ( 32 ) \\ {A}_{6} \leq βη \dot{θ} ( L , t ) \dot{M} ( t ) - \frac{β η GJ}{2 {L}^{2}} {\int }_{0}^{L} {[ \dot{θ} ( x , t ) ] }^{2} dx - \frac{β η GJ}{2} {\int }_{0}^{L} {[ {\dot{θ}}^{′} ( x , t ) ] }^{2} dx & ( 33 )\end{matrix}$$

Based on the above A1˜A6, we acquire \dot{V}₁(t) as follows:

$${\dot{V}}_{1} ( t ) \leq - ( \frac{β η {EI}_{b}}{2 {L}^{4}} - {σ}_{1} β ) {\int }_{0}^{L} {[ \dot{y} ( x , t ) ]}^{2} dx - ( \frac{β η GJ}{2 {L}^{2}} - {σ}_{2} β {x}_{a} c ) {\int }_{0}^{L} {[ \dot{θ} ( x , t ) ] }^{2} dx - \frac{β η {EI}_{b}}{2} {\int }_{0}^{L} {[ {\dot{y}}^{″} ( x , t ) ]}^{2} dx - \frac{β η GJ}{2} {\int }_{0}^{L} {[ {\dot{θ}}^{′} ( x , t ) ] }^{2} dx + β {mx}_{e} c {\int }_{0}^{L} [ \dot{y} ( x , t ) \ddot{θ} ( x , t ) + \ddot{y} ( x , t ) \dot{θ} ( x , t ) ] dx - β \dot{y} ( L , t ) [ F ( t ) + η \dot{F} ( t ) ] + β \dot{θ} ( L , t ) [ M ( t ) + η \dot{M} ( t ) ] + ( \frac{β}{{σ}_{1}} + \frac{β {x}_{a} c}{{σ}_{2}} ) {LF}_{b max}^{2} . \qquad ( 34 )$$

Similarly, by means of calculating the derivation of Δ(t) to t is deduced as

\dot{Δ}(t)=B₁+B₂+. . . B₈ (35),

B₁=−αEI_{b}∫₀^{L}y(x, t)y″″(x, t)dx (36),

B₂=−αηEI_{b}∫₀^{L}y(x, t)\dot{y}″″(x, t)dx (37),

B₃=αGJ∫₀^{L}θ(x, t)θ″(x, t)dx (38),

B₄=αηGJ∫₀^{L}θ(x, t)\dot{θ}″(x, t)dx (39),

B₅=αm∫₀^{L}[\dot{y}(x, t)]³dx+αIₚ∫₀^{L}[\dot{θ}(x, t)]²dx (40),

B₆=−βmxₒc∫₀^{L}[\dot{y}(x, t)\ddot{θ}(x, t)+ÿ(x, t)\dot{θ}(x, t)]dx (41),

B₇=−2αmxₒc∫₀^{L}\dot{y}(x, t)\dot{θ}(x, t)dx (42) and

B₈=α∫₀^{L}y(x, t)F_{b}(x, t)dx−αxₒc∫₀^{L}θ(x, t)F_{b}(x, t)dx (43).

By means of introducing the boundary conditions into the above formulas, we obtain:

$$\begin{matrix} {B}_{1} = - α y ( L , t ) F ( t ) - α {EI}_{b} {\int }_{0}^{L} {[ {y}^{″} ( x , t ) ]}^{2} dx , & ( 44 ) \\ {B}_{2} \leq - α η y ( L , t ) \dot{F} ( t ) + \frac{α η {EI}_{b}}{{σ}_{3}} {\int }_{0}^{L} {[ {y}^{″} ( x , t ) ]}^{2} dx + {σ}_{3} α η {EI}_{b} {\int }_{0}^{L} {[ {\dot{y}}^{″} ( x , t ) ]}^{2} dx , & ( 45 ) \\ {B}_{3} = α θ ( L , t ) M ( t ) - α GJ {\int }_{0}^{L} {[ {θ}^{′} ( x , t ) ]}^{2} dx , & ( 46 ) \\ {B}_{4} \leq α η θ ( L , t ) \dot{M} ( t ) + \frac{α η GJ}{{σ}_{4}} {\int }_{0}^{L} {[ {θ}^{′} ( x , t ) ]}^{2} dx + {σ}_{4} α η GJ {\int }_{0}^{L} {[ {\dot{θ}}^{′} ( x , t ) ]}^{2} dx , & ( 47 ) \\ {B}_{7} \leq 2 α {mx}_{e} c {σ}_{5} {\int }_{0}^{L} {[ \dot{y} ( x , t ) ]}^{2} dx + \frac{2 α {mx}_{e} c}{{σ}_{5}} {\int }_{0}^{L} {[ \dot{θ} ( x , t ) ]}^{2} dx , \\ and & ( 48 ) \\ {B}_{8} \leq {σ}_{6} α {L}^{4} {\int }_{0}^{L} {[ {y}^{″} ( x , t ) ]}^{2} dx + {σ}_{7} α {x}_{a} {cL}^{2} {\int }_{0}^{L} {[ {θ}^{′} ( x , t ) ]}^{2} dx + ( \frac{α}{{σ}_{6}} + \frac{α {x}_{a} c}{{σ}_{7}} ) {LF}_{b max}^{2} , & ( 49 )\end{matrix}$$

All the above σ₃-σ₇ are the positive constants;

Therefore, according to B₁-B₈, we obtain:

$$\dot{Δ} ( t ) \leq - ( α {EI}_{b} - \frac{α η {EI}_{b}}{{σ}_{3}} - {σ}_{6} α {L}^{4} ) {\int }_{0}^{L} {[ {y}^{″} ( x , t ) ]}^{2} dx - ( α GJ - \frac{α η GJ}{{σ}_{4}} - {σ}_{7} α {x}_{a} c {L}^{2} ) {\int }_{0}^{L} {[ {θ}^{′} ( x , t ) ] }^{2} dx + ( α m + 2 α {mx}_{e} c {σ}_{5} ) {\int }_{0}^{L} {[ \dot{y} ( x , t ) ] }^{2} dx + ( α {I}_{p} + \frac{2 α {mx}_{e} c}{{σ}_{5}} ) {\int }_{0}^{L} {[ \dot{θ} ( x , t ) ] }^{2} dx + {σ}_{3} α η {EI}_{b} {\int }_{0}^{L} {[ {\dot{y}}^{″} ( x , t ) ] }^{2} dx + {σ}_{4} α η GJ {\int }_{0}^{L} {[ {\dot{θ}}^{′} ( x , t ) ] }^{2} dx - β {mx}_{e} c {\int }_{0}^{L} {[ \dot{y} ( x , t ) \ddot{θ} ( x , t ) + \ddot{y} ( x , t ) \dot{θ} ( x , t ) ] }^{2} dx + α θ ( L , t ) [ M ( t ) + η \dot{M} ( t ) ] - α y ( L , t ) [ F ( t ) + η \dot{F} ( t ) ] + ( \frac{α}{{σ}_{6}} + \frac{α {x}_{a} c}{{σ}_{7}} ) {LF}_{b max}^{2} \qquad ( 50 )$$

Based on the formulas of (34) and (50), we obtain:

$$\dot{V} ( t ) \leq - [ α y ( L , t ) + β \dot{y} ( L , t ) ] [ F ( t ) + η \dot{F} ( t ) ] + [ α θ ( L , t ) + β \dot{θ} ( L , t ) ] [ M ( t ) + η \dot{M} ( t ) ] - ( α {EI}_{b} - \frac{α η {EI}_{b}}{{σ}_{3}} - {σ}_{6} α {L}^{4} ) {\int }_{0}^{L} {[ {y}^{″} ( x , t ) ]}^{2} dx - ( α GJ - \frac{α η GJ}{{σ}_{4}} - {σ}_{7} α {x}_{a} c {L}^{2} ) {\int }_{0}^{L} {[ {θ}^{′} ( x , t ) ] }^{2} dx - ( \frac{β η {EI}_{b}}{2 {L}^{4}} - {σ}_{1} β - α m - 2 α {mx}_{e} c {σ}_{5} ) {\int }_{0}^{L} {[ \dot{y} ( x , t ) ] }^{2} dx - ( \frac{β η GJ}{2 {L}^{2}} - {σ}_{2} β {x}_{a} c α {I}_{p} - α {I}_{p} - \frac{2 α {mx}_{e} c}{{σ}_{5}} ) {\int }_{0}^{L} {[ \dot{θ} ( x , t ) ] }^{2} dx - ( \frac{β η {EI}_{b}}{2} - {σ}_{3} α η {EI}_{b} ) {\int }_{0}^{L} {[ {\dot{y}}^{″} ( x , t ) ]}^{2} dx - ( \frac{β η GJ}{2} - {σ}_{4} α η GJ ) {\int }_{0}^{L} {[ {\dot{θ}}^{′} ( x , t ) ]}^{2} dx + ( \frac{β}{{σ}_{1}} + \frac{β {x}_{a} c}{{σ}_{2}} + \frac{α}{{σ}_{6}} + \frac{α {x}_{a} c}{{σ}_{7}} ) {LF}_{b max}^{2} . \qquad ( 51 )$$

By setting U(t)=F(t)+η\dot{F}(t) and V(t)=M(t)+η\dot{M}(t) as the new control variables, and their control rates are designed as follows:

U(t)=k₁[αy(L, t)+β\dot{y}(L, t)] (52),

V(t)=−k₂[αθ(L, t)+β\dot{θ}(L, t)] (53),

Wherein k₁≧0,k₂≧0 are the controlled gains.

Preferably, only need to set

$$\frac{βη {EI}_{B}}{2} - {σ}_{3} α η {EI}_{b} \geq 0 and$$

$$\frac{βη GJ}{2} - {σ}_{4} α η GJ \geq 0 ,$$

we further obtain:

\dot{V}(t)≦μ₁∫₀^{L}[\dot{y}(x, t)]²dx−μ₂∫₀^{L}[\dot{θ}(x, t)²dx −μ₃∫₀^{L}[y″(x, t)]²dx−μ₄∫₀^{L}[θ′(x, t)]²dx+ε−λ₃κ(t)ε (54),

### Wherein

$$\begin{matrix}{μ}_{1} = \frac{β η {EI}_{b}}{2 {L}^{4}} - {σ}_{1} β - α m - 2 α {mx}_{e} c {σ}_{5} > 0 , & ( 55 ) \\ {μ}_{2} = \frac{β η GJ}{2 {L}^{2}} - {σ}_{2} β {x}_{a} c α {I}_{p} - α {I}_{p} - \frac{2 α {mx}_{e} c}{{σ}_{5}} > 0 , & ( 56 ) \\ {μ}_{3} = α {EI}_{b} - \frac{α η {EI}_{b}}{{σ}_{3}} - {σ}_{6} α {L}^{4} > 0 , & ( 57 ) \\ {μ}_{4} = α GJ - \frac{α η GJ}{{σ}_{4}} - {σ}_{7} α {x}_{a} {cL}^{2} > 0 , & ( 58 ) \\ {λ}_{3} = min ( {μ}_{1} , {μ}_{2} , {μ}_{3} , {μ}_{4} ) > 0 and & ( 59 ) \\ ɛ = ( \frac{β}{{σ}_{1}} + \frac{β {x}_{a} c}{{σ}_{2}} + \frac{α}{{σ}_{6}} + \frac{α {x}_{a} c}{{σ}_{7}} ) {LF}_{b max}^{2} & ( 60 )\end{matrix}$$

According to formulas of (19) and (54), we obtain:

\dot{V}(t)≦−λV(t)+ε (61),

wherein λ=λ₃/λ₁, the above formula shows that only by means of selecting the parameters, we can guarantee that \dot{V}(t) is negative definite.

Preferably, by integrating the inequation of (61), we obtain:

$$V ( t ) \leq ( V ( 0 ) - \frac{ɛ}{λ} ) {e}^{- λ t} + \frac{ɛ}{λ} \leq V ( 0 ) {e}^{- λ t} + \frac{ɛ}{λ} ∈ {L}_{∞} . \qquad ( 62 )$$

This means that V(t) is bounded. Further,

$$\begin{matrix}\frac{1}{{L}^{3}} {y}^{2} ( x , t ) \leq \frac{1}{{L}^{2}} {\int }_{0}^{L} {[ {y}^{′} ( x , t ) ]}^{2} dx \leq {\int }_{0}^{L} {[ {y}^{″} ( x , t ) ]}^{2} dx \leq κ ( t ) \leq \frac{1}{{λ}_{2}} V ( t ) ∈ {L}_{∞} & ( 63 ) \\ and & \\ \frac{1}{L} {θ}^{2} ( x , t ) \leq \frac{1}{{L}^{2}} {\int }_{0}^{L} {[ {θ}^{′} ( x , t ) ]}^{2} dx \leq κ ( t ) \leq \frac{1}{{λ}_{2}} V ( t ) ∈ {L}_{∞} & ( 64 )\end{matrix}$$

is established, and thus we obtain:

$$\begin{matrix}\vert y ( x , t ) \vert \leq \sqrt{\frac{{L}^{3}}{{λ}^{2}} ( V ( 0 ) {e}^{- λ t} + \frac{ɛ}{λ} )} \\ and & ( 65 ) \\ \vert θ ( x , t ) \vert \leq \sqrt{\frac{L}{{λ}^{2}} ( V ( 0 ) {e}^{- λ t} + \frac{ɛ}{λ} )} . & ( 66 )\end{matrix}$$

When t tends to infinity, we obtain:

$$\begin{matrix}\vert y ( x , t ) \vert \leq \sqrt{\frac{{L}^{3} ɛ}{{λ}_{2} λ}} , \\ ∀ x ∈ [ 0 , L ] and & ( 67 ) \\ \vert θ ( x , t ) \vert \leq \sqrt{\frac{L ɛ}{{λ}_{2} λ}} , \\ ∀ x ∈ [ 0 , L ] . & ( 68 )\end{matrix}$$

This means that the system state y(x, t) and θ(x, t) are uniform bound.

To sum up, based on the Liapunov direct method, we can know that, by means of utilizing the boundary controls (52) and (53) to the systems described by the control equations (8) and (9) and the boundary condition (10), (11) and (12), we can realize that the closed-loop system possesses the uniform boundedness properties.

The examples of this invention focused on the method for controlling the oscillation of flapping-wing air vehicle. Below, we will perform the numerical simulation based on the MTLAB platform to verify the effect of the controller proposed for the problem of flexible wing deformation. By means of adopting the finite-difference approximation, we obtained the approximate values of the quantity of state in the formulas (8) and (9). The systematic parameters are shown in the following table:

TABLE 1
Table of parameters of the flexible wing of the air vehicle

| Parameter | | Value | |
|---|---|---|---|
| L | Length of the wings | 2 | m |
| m | Mass of per unitspan | 10 | kg/m |
| Iₚ | Polar moment of inertia of | 1.5 | kgm |
| | the intersecting surface of | | |
| | the wings | | |
| EI_{b} | Flexural rigidity | 0.12 | Nm² |
| GJ | Torsion resisting stiffness | 0.2 | Nm² |
| x_{c}c | Distance from the wing | 0.05 | m |
| | center of mass to the | | |
| | shear centre | | |
| xₐc | Distance from the | 0.05 | m |
| | aerodynamic center to the | | |
| | shear centre | | |

| | | |
|---|---|---|
| η | Kelvin-Voigt damping | 0.05 |
| | coefficient | |

The starting conditions for the simulation is

$$y ( x , 0 ) = \frac{x}{L} , \\ θ ( x , 0 ) = \frac{π x}{2 L} , \\ \dot{y} ( x , 0 ) = 0 , \\ \dot{θ} ( x , 0 ) = 0$$

when the distributed disturbance is F_{b}(x, t)=[1+sin (πt)+3 cos (3πt)]x.

The simulation diagrams 2 and 3 showed demonstrated that the boundary controllers designed in this invention are able to prevent the deformation of the inflexible wing effectively.

The oscillation control device in this invention for the flapping-wing air vehicle adopted the method special to the flapping-wing air vehicle, so that the characteristics of the oscillation control device for the flapping-wing air vehicle are the same as those of the method for oscillation control of the flapping-wing air vehicle and won't be given unnecessary details

What is said above is the preferred embodiment of this invention. It should be pointed out that the skilled person in the field of this technology is also able to think out a number of improvements and modifications without far away from the principle stated in this invention, and these improvements and modifications are also should also be considered as the scope of protection of this invention.

We claim:

1. A method for controlling the oscillation of flapping-wing air vehicle, comprising the following steps:
Calculating the kinetic energy, potential energy, and virtual work of the system using the flexible wing as the research object;
Establishing the Hamilton's principle based system dynamics model;
Setting the boundary control rate according to said system dynamics model wherein said boundary control rate includes F(t) and M(t), said F(t) is the inputted boundary control force, and M(t) is the inputted boundary torque; and
Controlling the flexible wings according to the system dynamics model and combining the boundary control rate.

2. The method for controlling the oscillation of flapping-wing air vehicle of claim 1, characterized in that said calculating the kinetic energy, potential energy, and virtual work of the system using the flexible wing as the research object comprises:
the kinetic energy of the system, Eₖ(t) is expressed as follows:
$${E}_{k} ( t ) = \frac{1}{2} m {\int }_{0}^{L} {[ \dot{y} ( x , t ) ]}^{2} dx + \frac{1}{2} {I}_{p} {\int }_{0}^{L} {[ \dot{θ} ( x , t ) ]}^{2} dx , \qquad ( 1 )$$
wherein the spatial variable of x is independent to the time variable of t, and m is the unitspan mass of the flexible wing; Iₚ is inertial polar distance of the flexible wing; y(x, t) is the bending displacement at the position of x and at time of t in the x0y coordinate system; and θ(x, t) is the corresponding displacement of deflection angle;
Potential energy of Eₚ(t) is expressed as follows:
$${E}_{p} ( t ) = \frac{1}{2} {EI}_{b} {\int }_{0}^{L} {[ {y}^{″} ( x , t ) ]}^{2} dx + \frac{1}{2} GJ {\int }_{0}^{L} {[ {θ}^{′} ( x , t ) ]}^{2} dx , \qquad ( 2 )$$
wherein, EI_{b} denotes the flexural rigidity, and GJ denotes the torsional rigidity;
and the virtual work of δW_{c}(t) caused by the above two rigidities is expressed as follows:
δW_{c}(t)=mxₒc∫₀^{L}ÿ(x, t)δθ(x, t)dx+mxₒc∫₀^{L}\ddot{θ}(x, t)δy(x, t)dx (3),
wherein xₒc denotes the distance from the mass center of wing to the bending center; and the virtual work of δW_{d}(t) provided by the Kelvin-Voigt damping force is expressed as follows:
δW_{d}(t)=−ηEI_{b}∫₀^{L}\dot{y}″(x, t)δy″(x, t)dx−ηGJ_{b}∫₀^{L}\dot{θ}′(x, t)δθ′(x, t)dx (4),
wherein, η denotes the Kelvin-Voigtd damping coefficient;
the virtual work of δWᵣ(t) done by the distributed distraction is expressed as follows:
δWᵣ(t)=∫₀^{L}[F_{b}(x, t)δy(x, t)−xₐcF_{b}(x, t)δθ(x, t)]dx (5),
wherein xₐc denotes the distance from the aerodynamic center to the bending centre and F_{b} is the unknown time varying distributed distraction along the wings;
the virtual work of δWₐ(t) done by the boundary control force to the system is expressed as follows:
δWₐ(t)=F(t)δy(L, t)+M(t)δθ(L, t) (6),
In the above formula, F(t) is the inputted boundary control force and M(t) is the inputted boundary torque;
Consequently, the total virtual work is:
δW(t)=δ[W_{c}(t)+W_{d}(t)+Wᵣ(t)+Wₐ(t)] (7).

3. The method for controlling the oscillation of flapping-wing air vehicle of claim 1, characterized in that, said establishing the system dynamics model based on the Hamilton's principle includes:
utilizing the Hamilton's smooth action principle of
∫ₜ_{₁}^{t}^{₂}δ[Eₖ(t)−Eₚ(t)+W(t)]dt=0
Here δ denotes the variation symbol, and the governing equation for the system dynamics model is deduced as:
mÿ(x, t)+EI_{b}y″″(x, t)−mxₒc\ddot{θ}(x, t)+ηEI_{b}\dot{y}″″(x, t)=F_{b}(x, t) (8)
Iₚ\ddot{θ}(x, t)−GJθ″(x, t)−mxₒcÿ(x, t)−ηGJ\dot{θ}″(x, t)=−xₐcF_{b}(x, t) (9)
And the boundary conditions for the system dynamics model are deduced as:
y(0, t)=y′(0, t)=y″(L, t)=θ(0, t)=0 (10),
EI_{b}y′″(L, t)+ηEI_{b}\dot{y}′″(L, t)=−F(t) (11) and
GJθ′(L, t)+ηGJ\dot{θ}′(L, t)=M(t) (12).

4. The method for controlling the oscillation of flapping-wing air vehicle of claim 3, characterized in that, said setting the boundary controller based on the system dynamics model includes two controlling laws of F(t) and M(t) wherein said F(t) is the inputted boundary control force and said M(t) is the inputted boundary torque, and includes:
Constructing the Lyapunov candidate function as follows:
V(t)=V₁+Δ(t) (13)
Wherein, V₁(t) and Δ(t) are respectively defined as:
$$\begin{matrix}{V}_{1} ( t ) = \frac{β}{2} m {\int }_{0}^{L} {[ \dot{y} ( x , t ) ]}^{2} dx + \frac{β}{2} {EI}_{b} {\int }_{0}^{L} {[ {y}^{″} ( x , t ) ]}^{2} dx + {\frac{β}{2} {I}_{p} {\int }_{0}^{L} {[ \dot{θ} ( x , t ) ]}^{2} dx + \frac{β}{2} GJ {\int }_{0}^{L} {θ}^{′} ( x , t ) ]}^{2} dx , & ( 14 ) \\ Δ ( t ) = α m {\int }_{0}^{L} \dot{y} ( x , t ) y ( x , t ) dx + α {I}_{p} {\int }_{0}^{L} \dot{θ} ( x , t ) θ ( x , t ) dx - α {mx}_{e} c {\int }_{0}^{L} [ \dot{y} ( x , t ) θ ( x , t ) + y ( x , t ) \dot{θ} ( x , t ) ] dx - β {mx}_{e} c {\int }_{0}^{L} \dot{y} ( x , t ) \dot{θ} ( x , t ) dx ; & ( 15 )\end{matrix}$$
In the above two equations, both α and β are the smaller positive weight coefficient;
the boundary control rate is set by means of making the Lyapunov candidate function be positive definite, and making the derivative of Lyapunov candidate function of \dot{V}(t) to the time of t be negative definite.

5. The method for controlling the oscillation of flapping-wing air vehicle of claim 4, characterized in that, said calculating the boundary control rate when the Lyapunov candidate function is positive definite, and the derivative of Lyapunov candidate function of \dot{V}(t) to the time of t is negative definite includes:
defining a new function as follows:
κ(t)=∫₀^{L}{[\dot{y}(x, t)]²+[\dot{θ}(x, t)]²+[y″(x, t)]²+[θ′(x, t)]²}dx (16),
Then V₁(t) has the upper bound and lower bound which are defined as
γ₂κ(t)≦V₁(t)≦γ₁κ(t) (17),
In the above formula,
$${γ}_{1} = \frac{β}{2} max ( m , {I}_{p} , {EI}_{b} , GJ ) , \\ {γ}_{2} = \frac{β}{2} min ( m , {I}_{p} , {EI}_{b} , GJ ) ;$$
Further, Δ(t) is magnified as:
$$\vert Δ ( t ) \vert \leq ( α m + α {mx}_{e} c + β {mx}_{e} c ) {\int }_{0}^{L} {[ \dot{y} ( x , t ) ]}^{2} dx + ( α {I}_{p} + α {mx}_{e} c + β {mx}_{e} c ) {\int }_{0}^{L} {[ \dot{θ} ( x , t ) ]}^{2} dx + ( α m + α {mx}_{e} c ) {L}^{4} {\int }_{0}^{L} {[ {y}^{″} ( x , t ) ]}^{2} dx + ( α {I}_{p} + α {mx}_{e} c ) {L}^{2} {\int }_{0}^{L} {[ {θ}^{′} ( x , t ) ]}^{2} dx \leq {y}_{3} κ ( t ) , \qquad ( 18 )$$
wherein
γ₃=max{αm+αmxₒc+βmxₒc, αIₚ+αmxₒc+βmxₒc, (αm+αmxₒc)L⁴, (αIₚ+αmxₒc)L²}, if the positive number of β satisfies
$$β > \frac{2 {γ}_{3}}{min ( m , {I}_{p} , {EI}_{b} , GJ )} ,$$
then
0≦λ₂κ(t)≦V(t)≦λ₃κ(t) (19),
which means that the constructed Lyapunov function is positive definite, wherein
λ₁=γ₁+γ₃ and λ₂=γ₂−γ₃;
by calculating the derivative of V(t) to t, we obtain:
\dot{V}(t)=\dot{V}₁(t)+\dot{Δ}(t) (20),
\dot{V}₁(t)=βm∫₀^{L}\dot{y}(x, t)ÿ(x, t)dx+βIₚ∫₀^{L}\dot{θ}(x, t)\ddot{θ}(x, t)dx +βGJ∫₀^{L}θ′(x, t)\dot{θ}′(x, t)dx+βEI_{b}∫₀^{L}y″(x, t)\dot{y}″(x, t)dx (21)
by introducing the controlling equation (8) and (9) into the above formula, we obtain:
\dot{V}₁(t)=A₁+A₂+A₃+A₄+A₅+A₆ (22),
Wherein, A₁˜A₆ are respectively expressed as follows
A₁=−βEI_{b}∫₀^{L}\dot{y}(x, t)y″″(x, t)dx+βEI_{b}∫₀^{L}y″(x, t)\dot{y}″(x, t)dx (23),
A₂=−βηEI_{b}∫₀^{L}\dot{y}(x, t)\dot{y}″″(x, t)dx (24),
A₃=βmxₒc ∫₀^{L}[\dot{y}(x, t)\ddot{θ}(x, t)+ÿ(x, t)\dot{θ}(x, t)]dx (25),
A₄=β∫₀^{L}\dot{y}(x, t)F_{b}(x, t)dx−βxₒc∫₀^{L}\dot{θ}(x, t)F_{b}(x, t)dx (26),
A₅=βGJ∫₀^{L}\dot{θ}(x, t)θ″(x, t)dx+βGJ∫₀^{L}θ′(x, t)\dot{θ}′(x, t)dx (27), and
A₆=βηGJ∫₀^{L}\dot{θ}(x, t)\dot{θ}″(x, t)dx (28),
By utilizing the integration by parts and the ba nary condition of (10), (11) and (12), we obtain
$$\begin{matrix} {A}_{1} = - β {EI}_{b} \dot{y} ( L , t ) {y}^{′′′} ( L , t ) = - β \dot{y} ( L , t ) F ( t ) , & ( 29 ) \\ {A}_{2} \leq - β η y ( L , t ) \dot{F} ( t ) - \frac{β η {EI}_{b}}{2 {L}^{4}} {\int }_{0}^{L} {[ \dot{y} ( x , t ) ]}^{2} dx - \frac{β η {EI}_{b}}{2} {\int }_{0}^{L} {[ {\dot{y}}^{″} ( x , t ) ]}^{2} dx , and & ( 30 ) \\ {A}_{4} \leq {σ}_{1} β {\int }_{0}^{L} {[ \dot{y} ( x , t ) ]}^{2} dx + {σ}_{2} β {x}_{a} c {\int }_{0}^{L} {[ \dot{θ} ( x , t ) ]}^{2} dx + ( \frac{β}{{σ}_{1}} + \frac{β {x}_{a} c}{{σ}_{2}} ) {LF}_{b max}^{2} , & ( 31 )\end{matrix}$$
wherein and σ₁ and σ₂ are the positive constant, F_{b max} is the maximum value of the distributed disturbance of F_{b}(x, t);
$$\begin{matrix} {A}_{5} = β BJ \dot{θ} ( L , t ) {θ}^{′} ( L , t ) = β \dot{θ} ( L , t ) M ( t ) & ( 32 ) \\ {A}_{6} \leq β η \dot{θ} ( L , t ) \dot{M} ( t ) - \frac{β η GJ}{2 {L}^{2}} {\int }_{0}^{L} {[ \dot{θ} ( x , t ) ]}^{2} dx - \frac{β η GJ}{2} {\int }_{0}^{L} {[ {\dot{θ}}^{′} ( x , t ) ]}^{2} dx & ( 33 )\end{matrix}$$
Based on the above A1˜A6, we acquire \dot{V}₁(t) as follows:
$${\dot{V}}_{1} ( t ) \leq - ( \frac{β η {EI}_{b}}{2 {L}^{4}} - {σ}_{1} β ) {\int }_{0}^{L} {[ \dot{y} ( x , t ) ]}^{2} dx - ( \frac{β η GJ}{2 {L}^{2}} - {σ}_{2} β {x}_{a} c ) {\int }_{0}^{L} {[ \dot{θ} ( x , t ) ]}^{2} dx - \frac{β η {EI}_{b}}{2} {\int }_{0}^{L} {[ {\dot{y}}^{″} ( x , t ) ]}^{2} dx - \frac{β η GJ}{2} {\int }_{0}^{L} {[ {\dot{θ}}^{′} ( x , t ) ]}^{2} dx + β {mx}_{e} c {\int }_{0}^{L} [ \dot{y} ( x , t ) \ddot{θ} ( x , t ) + \ddot{y} ( x , t ) \dot{θ} ( x , t ) ] dx - β \dot{y} ( L , t ) [ F ( t ) + η \dot{F} ( t ) ] + β \dot{θ} ( L , t ) [ M ( t ) + η \dot{M} ( t ) ] + ( \frac{β}{{σ}_{1}} + \frac{β {x}_{a} c}{{σ}_{2}} ) {LF}_{b max}^{2} \qquad ( 34 )$$
similarly, by means of calculating the derivation of Δ(t) to t, we obtain:
\dot{Δ}(t)=B₁+B₂+. . . B₈ (35),
B₁=−αEI_{b}∫₀^{L}y(x, t)y″″(x, t)dx (36),
B₂=−αηEI_{b}∫₀^{L}y(x, t)\dot{y}″″(x, t)dx (37),
B₃=αGJ∫₀^{L}θ(x, t)θ″(x, t)dx (38),
B₄=αηGJ∫₀^{L}θ(x, t)\dot{θ}″(x, t)dx (39),
B₅=αm∫₀^{L}[\dot{y}(x, t)]³dx+αIₚ∫₀^{L}[\dot{θ}(x, t)]²dx (40),
B₆=−βmxₒc∫₀^{L}[\dot{y}(x, t)\ddot{θ}(x, t)+ÿ(x, t)\dot{θ}(x, t)]dx (41),
B₇=−2αmxₒc∫₀^{L}\dot{y}(x, t)\dot{θ}(x, t)dx (42), and
B₈=α∫₀^{L}y(x, t)F_{b}(x, t)dx−αxₒc∫₀^{L}θ(x, t)F_{b}(x, t)dx (43);
By means of introducing the boundary conditions into the above formulas, we obtain:
$$\begin{matrix} {B}_{1} = - α y ( L , t ) F ( t ) - α {EI}_{b} {\int }_{0}^{L} {[ {y}^{″} ( x , t ) ]}^{2} dx , & ( 44 ) \\ {B}_{2} \leq - α η y ( L , t ) \dot{F} ( t ) + \frac{α η {EI}_{b}}{{σ}_{3}} {\int }_{0}^{L} {[ {y}^{″} ( x , t ) ]}^{2} dx + {σ}_{3} α η {EI}_{b} {\int }_{0}^{L} {[ {\dot{y}}^{″} ( x , t ) ]}^{2} dx , & ( 45 ) \\ {B}_{3} = α θ ( L , t ) M ( t ) - α GJ {\int }_{0}^{L} {[ {θ}^{′} ( x , t ) ]}^{2} dx , & ( 46 ) \\ {B}_{4} \leq α η θ ( L , t ) \dot{M} ( t ) + \frac{α η GJ}{{σ}_{4}} {\int }_{0}^{L} {[ {θ}^{′} ( x , t ) ]}^{2} dx + {σ}_{4} α η GJ {\int }_{0}^{L} {[ {\dot{θ}}^{′} ( x , t ) ]}^{2} dx , & ( 47 ) \\ {B}_{7} \leq 2 α {mx}_{e} c {σ}_{5} {\int }_{0}^{L} {[ \dot{y} ( x , t ) ]}^{2} dx + \frac{2 α {mx}_{e} c}{{σ}_{5}} {\int }_{0}^{L} {[ \dot{θ} ( x , t ) ]}^{2} dx , and & ( 48 ) \\ {B}_{8} \leq {σ}_{6} α {L}^{4} {\int }_{0}^{L} {[ {y}^{″} ( x , t ) ]}^{2} dx + {σ}_{7} α {x}_{a} {cL}^{2} {\int }_{0}^{L} {[ {θ}^{′} ( x , t ) ]}^{2} dx + ( \frac{α}{{σ}^{6}} + \frac{α {x}_{a} c}{{σ}_{7}} ) {LF}_{b max}^{2} , & ( 49 )\end{matrix}$$
and
All the above σ₃-σ₇ are the positive constant.
Therefore, according to B₁-B₈, we obtain formula of (50):
$$\dot{Δ} ( t ) \leq - ( α {EI}_{b} - \frac{αη {EI}_{b}}{{σ}_{3}} - {σ}_{6} α {L}^{4} ) {\int }_{0}^{L} {[ {y}^{″} ( x , t ) ]}^{2} dx - ( α GJ - \frac{αη GJ}{{σ}_{4}} - {σ}_{3} α {x}_{a} c {L}^{2} ) {\int }_{0}^{L} {[ {θ}^{′} ( x , t ) ]}^{2} dx + ( α m + 2 α {mx}_{e} c {σ}_{5} ) {\int }_{0}^{L} {[ \dot{y} ( x , t ) ]}^{2} dx + ( α {I}_{p} + \frac{2 α {mx}_{e} c}{{σ}_{5}} ) {\int }_{0}^{L} {[ \dot{θ} ( x , t ) ]}^{2} dx + {σ}_{3} αη {EI}_{b} {\int }_{0}^{L} {[ {\dot{y}}^{″} ( x , t ) ]}^{2} dx + {σ}_{4} αη GJ {\int }_{0}^{L} {[ {\dot{θ}}^{′} ( x , t ) ]}^{2} dx - β {mx}_{e} c {\int }_{0}^{L} [ \dot{y} ( x , t ) \ddot{θ} ( x , t ) + \ddot{y} ( x , t ) \dot{θ} ( x , t ) ] dx + α θ ( L , t ) [ M ( t ) + η \dot{M} ( t ) ] - α y ( L , t ) [ F ( t ) + η \dot{F} ( t ) ] + ( \frac{α}{{σ}_{6}} + \frac{α {x}_{a} c}{{σ}_{7}} ) {LF}_{b max}^{2} , \qquad ( 50 )$$
Based on the formulas of (34) and (50), we can obtain:
$$\dot{V} ( t ) \leq - [ α y ( L , t ) + β \dot{y} ( L , t ) ] [ F ( t ) + η \dot{F} ( t ) ] + [ α θ ( L , t ) + β \dot{ θ} ( L , t ) ] [ M ( t ) + η \dot{M} ( t ) ] - ( α {EI}_{b} - \frac{αη {EI}_{b}}{{σ}_{3}} - {σ}_{6} α {L}^{4} ) {\int }_{0}^{L} {[ {y}^{″} ( x , t ) ]}^{2} dx - ( α GJ - \frac{αη GJ}{{σ}_{4}} - {σ}_{7} α {x}_{a} c {L}^{2} ) {\int }_{0}^{L} {[ {θ}^{′} ( x , t ) ]}^{2} dx - ( \frac{βη {EI}_{b}}{2 {L}^{4}} - {σ}_{1} β - α m - 2 α {mx}_{e} c {σ}_{5} ) {\int }_{0}^{L} {[ \dot{y} ( x , t ) ]}^{2} dx - ( \frac{βη GJ}{2 {L}^{2}} - {σ}_{2} β {x}_{a} c α {I}_{p} - α {I}_{p} - \frac{2 α {mx}_{e} c}{{σ}_{5}} ) {\int }_{0}^{L} {[ \dot{θ} ( x , t ) ]}^{2} dx - ( \frac{β η {EI}_{b}}{2} - {σ}_{3} α η {EI}_{b} ) {\int }_{0}^{L} {[ {\dot{y}}^{″} ( x , t ) ] }^{2} dx - ( \frac{βη GJ}{2} - {σ}_{4} αη GJ ) {\int }_{0}^{L} {[ {\dot{θ}}^{′} ( x , t ) ]}^{2} dx + ( \frac{β}{{σ}_{1}} + \frac{β {x}_{a} c}{{σ}_{2}} + \frac{α}{{σ}_{6}} + \frac{α {x}_{a} c}{{σ}_{7}} ) {LF}_{b max}^{2} , \qquad ( 51 )$$
By setting U(t)=F(t)+η\dot{F}(t) and V(t)=M(t)+η\dot{M}(t) as the new controling variable, and their control rates are designed as follows:
U(t)=k₁[αy(L, t)+β\dot{y}(L, t)] (52),
V(t)=−k₂[αθ(L, t)+β\dot{θ}(L, t)] (53),
Wherein k₁≧0,k₂≧0 is the control gain.
